(19) United States
(12) Patent Application Publication
(10) Pub. No.: US 2021/0081596 A1
(43) Pub. Date: Mar. 18, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Akiko NAKAMURA, Kanagawa (JP)

(73) Assignee: FUJI XEROX CO., LTD., Tokyo (JP)

(21) Appl. No.: 16/824,086

(22) Filed: Mar. 19, 2020

(30) Foreign Application Priority Data
Sep. 18, 2019 (JP) 2019-169736

(51) Int. Cl. G06F 40/106; G06F 3/0481; G06F 3/0484; G06F 3/0488; G06F 40/166

(52) U.S. Cl. CPC G06F 40/106; G06F 3/04817; G06F 40/166; G06F 3/04886; G06F 3/04842

(57) ABSTRACT

An information processing apparatus includes a processor and a touch panel on which target data is displayed. The processor is configured to add additional data to the target data after switching an operation mode from a view mode, in which the target data is uneditable, to an edit mode, in which the target data is editable, in response to an operator's action for adding the additional data to the target data in the view mode.

### CROSS-REFERENCE TO RELATED APPLICATIONS

This application is based on and claims priority under 35 USC 119 from Japanese Patent Application No. 2019-169736 filed Sep. 18, 2019.

### BACKGROUND

### (i) Technical Field

The present disclosure relates to an information processing apparatus and a non-transitory computer readable medium.

### (ii) Related Art

Conventionally, information processing apparatuses having a touch panel are known. A user controls such an information processing apparatus by touching a touch panel with a finger or a stylus. In such a case, however, the user is more likely to control the information processing apparatus unintendedly than in a case where the user controls an information processing apparatus by using a peripheral input device such as a keyboard or a mouse. One reason for this is that in a case where the user designates a position on a screen with a finger or a stylus, accuracy of designation of the position tends to be lower than that in a case where the user designates a position on a screen by using a peripheral input device. Another reason is that in a case where the information processing apparatus which the user is operating is a mobile terminal, the user is holding the information processing apparatus with a hand and is therefore more likely to touch the touch panel unintendedly, whereas the user is less likely to touch a peripheral input device unintendedly.

An information processing apparatus has been proposed which has a view mode, which is an operation mode in which target data displayed on a touch panel is uneditable, and an edit mode, which is an operation mode in which the target data displayed on the touch panel is editable, in order to prevent an operator from editing the target data unintendedly (see, for example, Japanese Unexamined Patent Application Publication No. 2016-146134).

### SUMMARY

Conventionally, in a case where an operator who uses an information processing apparatus having a touch panel on which target data is displayed and having a view mode and an edit mode wants to edit the target data when viewing the target data in the view mode, the operator needs to switch an operation mode of the information processing apparatus from the view mode to the edit mode and then edit the target data.

Aspects of non-limiting embodiments of the present disclosure relate to reducing the number of actions needed by an operator who uses an information processing apparatus having a touch panel on which target data is displayed and having a view mode, which is an operation mode in which the target data displayed on the touch panel is uneditable, and an edit mode, which is an operation mode in which the target data displayed on the touch panel is editable, as compared with a case where an operator who wants to add additional data to the target data when the operation mode is the view mode first changes the operation mode to the edit mode and then adds the additional data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor and a touch panel on which target data is displayed. The processor is configured to add additional data to the target data after switching an operation mode from a view mode, in which the target data is uneditable, to an edit mode, in which the target data is editable, in response to an operator's action for adding the additional data to the target data in the view mode.

### BRIEF DESCRIPTION OF THE DRAWINGS

An exemplary embodiment of the present disclosure will be described in detail based on the following figures, wherein:

FIG. 1 schematically illustrates a configuration of an information processing apparatus according to the present exemplary embodiment;

FIG. 2 illustrates a display example of target data displayed on a touch panel;

FIG. 3 illustrates an example of designation of a part of the target data;

FIG. 4 illustrates an example of a first inquiring message;

FIG. 5 illustrates an example of a photographing screen;

FIG. 6 illustrates a state where an additional data button has been added at a position close to the designated part;

FIG. 7 illustrates a display example of additional data;

FIG. 8 illustrates a state where additional data has been added as a page next to a designated page;

FIG. 9 illustrates an example of a second inquiring message;

FIG. 10 illustrates a state where additional data has been added to the target data as a replacement for the designated page;

FIG. 11 illustrates a display example of candidates of the additional data;

FIG. 12 illustrates an example of an adding action for adding one of the candidates of the additional data;

FIG. 13 illustrates a state where a URL has been added as additional data; and

FIG. 14 is a flowchart illustrating flow of processing of the information processing apparatus according to the basic exemplary embodiment.

### DETAILED DESCRIPTION

Outline of Information Processing Apparatus

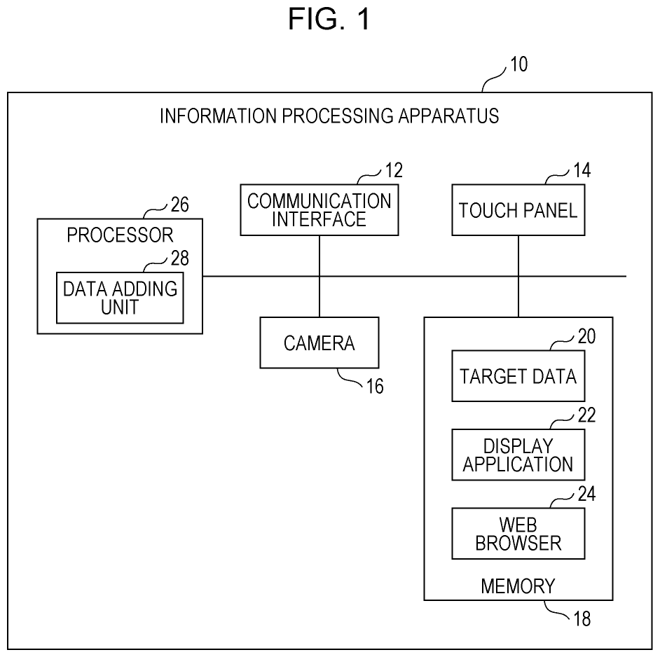

FIG. 1 schematically illustrates a configuration of an information processing apparatus 10 according to the present exemplary embodiment. The information processing apparatus 10 is a computer that is used to view target data. In the present exemplary embodiment, the information processing apparatus 10 is a mobile terminal which an operator (user) can carry. Note, however, that the information processing apparatus 10 may be any apparatus that can realize functions described below. For example, the information processing apparatus 10 may be a computer that is used on a desk or the like instead of a mobile terminal.

A communication interface 12 includes, for example, a wired or wireless LAN adapter. The communication interface 12 functions to communicate with another apparatus over a communication line such as a LAN or the Internet.

A touch panel 14 includes, for example, a liquid crystal display and a sensor for detecting contact of a finger or a stylus (hereinafter, these means to operate the touch panel 14 are collectively referred to as a “finger”) on a screen. The touch panel 14 functions as both a display and an input interface and therefore can display various screens and receive instructions from a user.

A camera 16 includes, for example, a lens and an imaging element. The camera 16 acquires image data by taking an image within a photographing region.

A memory 18 includes, for example, a hard disk, a solid state drive (SSD), a ROM, or a RAM. The memory 18 may be provided separately from a processor 26, which will be described later, or at least part of the memory 18 may be provided in the processor 26. In the memory 18, an information processing program for causing each unit of the information processing apparatus 10 to operate is stored.

As illustrated in FIG. 1, target data 20 is stored in the memory 18. The target data 20 is data that can be displayed on the touch panel 14 and can be edited by a user. In the present exemplary embodiment, the target data 20 is electronic document data having one or more pages. Note, however, that the target data 20 is not limited to this. Note that the “pages” as used herein refer to conceptual pages defined in the electronic document data and are a concept different from physical pages each printed on a single face of a printing medium when the electronic document data is actually printed. Although the target data 20 is stored in the memory 18 in the present exemplary embodiment, the target data 20 may be stored in an apparatus different from the information processing apparatus 10. In this case, the information processing apparatus 10 acquires the target data 20 by accessing this apparatus through the communication interface 12 and displays or edits the target data 20 thus acquired on the touch panel 14.

As illustrated in FIG. 1, a displaying application 22 and a web browser 24 are installed into the memory 18. The displaying application 22 and the web browser 24 are applications that operate on the information processing apparatus 10 in accordance with an instruction from the processor 26. The displaying application 22 is an application for displaying the target data 20 on the touch panel 14 and editing the target data 20 in accordance with an instruction from a user. The displaying application 22 can be, for example, Docuworks (Registered Trademark) offered by Fuji Xerox Co., Ltd. but is not limited to this.

The displaying application 22 can operate in a view mode, which is an operation mode in which the target data 20 is uneditable, and an edit mode, which is an operation mode in which the target data 20 is editable.

The web browser 24 is an application for displaying a web page acquired over the Internet by the communication interface 12 on the touch panel 14. When a user designates a Uniform Resource Locator (URL) for identifying a web page on the web browser 24, the web browser 24 can acquire the web page corresponding to the designated URL and causes the web page to be displayed on the touch panel 14. The user can download image data included in the web page corresponding to the designated URL into the memory 18 by using the web browser 24.

The processor 26 is a processing device in a broad sense and includes at least one of a general-purpose processing device (e.g., a central processing unit (CPU)) and a dedicated processing device (e.g., a graphics processing unit (GPU), an application specific integrated circuit (ASIC), a field programmable gate array (FPGA), or a programmable logic device). The processor 26 may be realized not by a single processing device but by cooperation of plural processing devices that are physically separate from one another.

The processor 26 causes each unit of the information processing apparatus 10 to operate in accordance with the information processing program stored in the memory 18. For example, the processor 26 causes the displaying application 22 installed in the memory 18 to operate. Since the displaying application 22 can operate in the view mode and the edit mode as described above, the processor 26 does not receive (i.e., ignores) an instruction from a user to edit the target data 20 displayed on the touch panel 14 while the displaying application is in the view mode. The edit is to make a change to contents or an attribute of the target data 20. Accordingly, even in the view mode, the user is allowed to change a displayed part (e.g., view) of the target data 20. Meanwhile, in a case where the displaying application 22 is in the edit mode, the processor 26 edits the target data 20 displayed on the touch panel 14 in accordance with an instruction from a user to edit the target data 20.

Furthermore, the processor 26 can capture all or part of a screen displayed on the touch panel 14 in accordance with an instruction from a user and acquire the captured part as image data.

As illustrated in FIG. 1, the processor 26 functions as a data adding unit 28. The data adding unit 28 adds additional data to the target data 20 that is displayed on the touch panel 14 by using the displaying application 22. Examples of the additional data include, but are not limited to, image (including moving image) data and additional page data (in a case where the target data 20 is electronic document data).

In particular, in a case where a user performs an adding action for adding additional data to the target data 20 on the displaying application 22 that is in the view mode, the data adding unit 28 automatically switches the operation mode of the displaying application 22 from the view mode to the edit mode and then adds the additional data to the target data 20 in accordance with the adding action. This will be described in detail later.

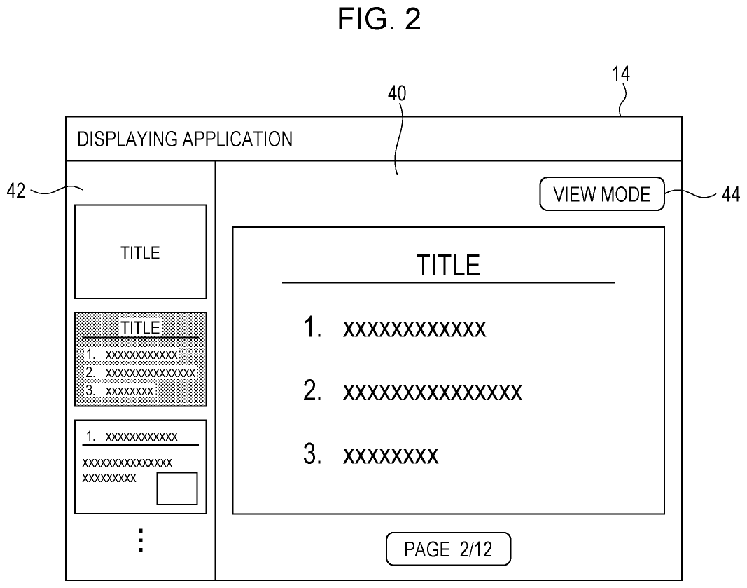

Details of processing of the data adding unit 28 according to a basic exemplary embodiment and modifications thereof are described below with reference to FIGS. 2 through 13. In the following description, it is assumed that a user of the information processing apparatus 10 is a participant of a conference, the target data 20 is conference material data having plural pages distributed by a presenter of the conference, and the user is viewing the target data 20 (i.e., the conference material data) during the conference on the displaying application 22 that is in the view mode. Note, however, that a situation in which the information processing apparatus 10 is used is not limited to this.

### Basic Exemplary Embodiment

FIG. 2 illustrates a display screen of the displaying application 22 displayed on the touch panel 14. The displaying application 22 has a first display region 40 and a thumbnail display region 42. In the first display region 40, a selected page of the target data 20 having plural pages is displayed in a larger size. In the thumbnail display region 42, not only the page displayed in the first display region 40, but also one or more pages before and after the page displayed in the first display region 40 are displayed in a smaller size.

It is desirable that the screen of the displaying application 22 be configured so that the user can tell which operation mode the displaying application 22 is currently in. In the example of FIG. 2, an operation mode indicator 44 indicative of the current operation mode is displayed in the first display region 40. Instead of or in addition to the operation mode indicator 44, a skin color of the displaying application 22 or a background color of the first display region 40 and/or the thumbnail display region 42 may be changed depending on the current operation mode.

In the basic exemplary embodiment (and modifications thereof, which will be described later), in a case where the operation mode of the displaying application 22 is the view mode, the user can add additional data without performing an action just for changing the operation mode from the view mode to the edit mode. The data adding unit 28 first changes the operation mode of the displaying application 22 from the view mode to the edit mode in response to this adding action and then adds the additional data designated by the adding action to target data.

For example, assume that a user who is a participant of a conference is listening to a presenter while viewing conference material data having plural pages, which is the target data 20, on the displaying application 22 that is in the view mode, and when the presenter displays a new material that is not included in the target data on a monitor for presentation, the user adds the new material to his or her conference material data.

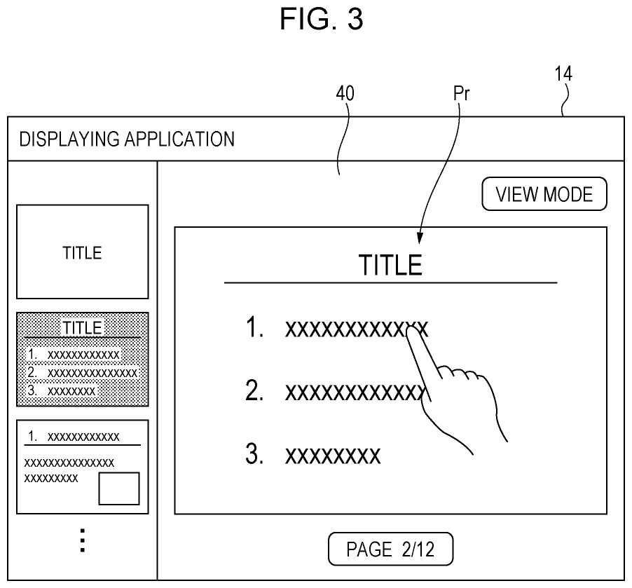

In the basic exemplary embodiment, first, the user designates a part of the target data 20. This designated part may be, for example, a part within a page of the target data 20 or any of the plural pages of the target data 20. Although the user can designate any part, it is assumed in this example that the user designates a part of the target data 20 that is related to the new material displayed by the presenter. For example, the user designates a part within a page displayed in the first display region 40 by touching this part with a finger, as illustrated in FIG. 3. Hereinafter, a page related to the designated part is referred to as a designated page Pr. The page related to the designated part is a page including the designated part in a case where the designated part designated by the user is a part within a page of the target data 20 and is a page designated by the user in a case where the designated part designated by the user is any of the pages of the target data 20. In the example of FIG. 3, the user designates Point 1 in the designated page Pr.

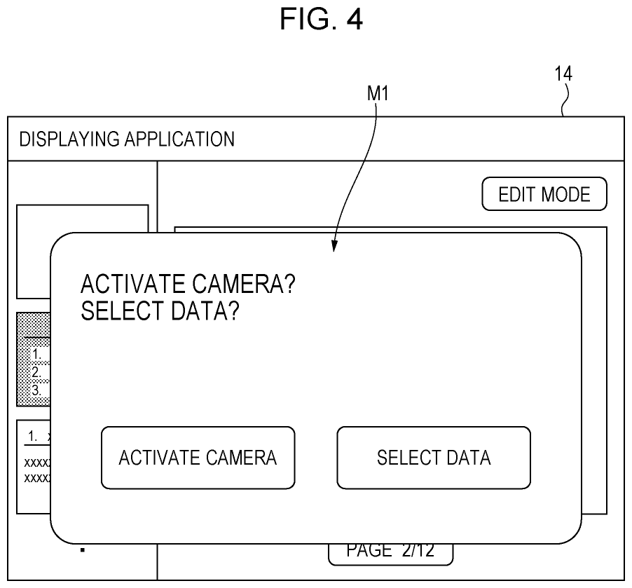

When the user designates a part of the target data 20, the data adding unit 28 causes an inquiring message M1 for inquiring of the user whether to activate the camera 16 or select prepared data to be displayed on the touch panel 14 as illustrated in FIG. 4. Instead of displaying the inquiring message M1 when the user designates a part of the target data 20, whether to activate the camera 16 or select prepared data when the user designates a part of the target data 20 may be determined in advance, for example, by user settings. To ensure a function of preventing unintended control, which is an original function of the view mode of the displaying application 22, it is desirable that an inquiring screen be displayed on the touch panel 14 when the user designates a part of the target data 20 not just by touching the part but by long-pressing or double-tapping the part.

When the user selects a “SELECT DATA” button on the inquiring message M1, the user selects additional data from among prepared data. The prepared data may be stored in the memory 18 or may be stored in another apparatus and acquired through the communication interface 12. In this case, this user's action for designating a part of the target data 20 and selecting additional data is the adding action.

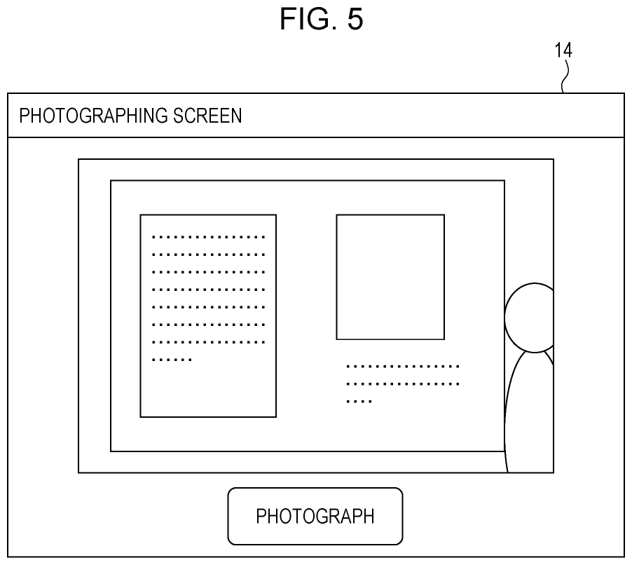

When the user selects an “ACTIVATE CAMERA” button on the inquiring message M1, the data adding unit 28 activates the camera 16 and causes a photographing screen (see FIG. 5) to be displayed on the touch panel 14. A photographing region is displayed on the photographing screen, and the user takes an image of the new material displayed on the monitor for presentation by the presenter by using the camera 16 while referring to the photographing screen and acquires image data of the image as additional data. As described above, the image data may be a still image or may be a moving image. In this case, this user's action for designating a part of the target data 20 and acquiring image data by using the camera 16 is the adding action.

When the photographing using the camera 16 is finished, the data adding unit 28 causes the displaying application 22 to be displayed again on the touch panel 14. The processor 26 changes the operation mode of the displaying application 22 from the view mode to the edit mode. Then, the data adding unit 28 adds the additional data to the target data 20 in association with the designated part.

Adding the additional data to the target data 20 in association with the designated part means adding the additional data to the target data 20 in a manner such that association between the designated part and the additional data can be understood later by the user. The data adding unit 28 adds the additional data within the designated page Pr in association with the designated part. In the present exemplary embodiment, the data adding unit 28 generates an additional data button 50 on the basis of the additional data and adds the additional data button 50 to the designated page Pr. When the additional data button 50 is operated, the additional data is displayed. A file path of the additional data (e.g., an address of the additional data in a folder structure of the information processing apparatus 10) is associated with the additional data button 50. An icon of the additional data button 50 may include a reduced-size image of the additional data.

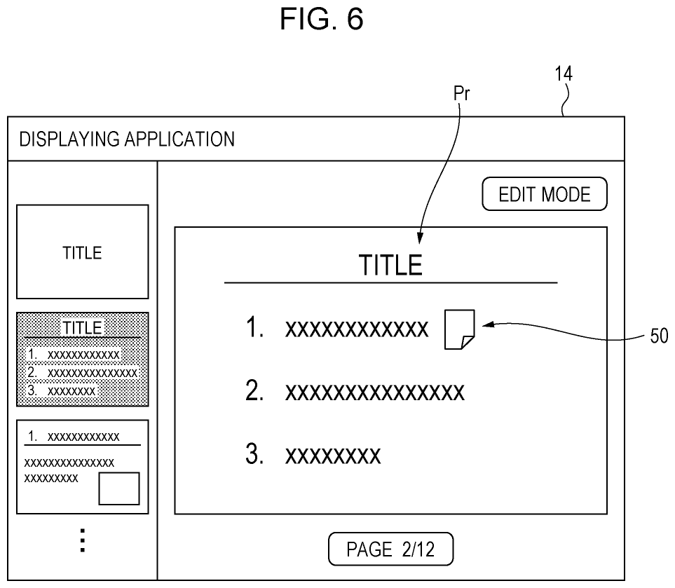

As illustrated in FIG. 6, the data adding unit 28 displays the additional data button 50 close to Point 1, which is the designated part. In this case, in a case where the designated part is a character string (Point 1) as illustrated in FIG. 6, the character string itself may be turned into the additional data button 50 by embedding link information in the character string of Point 1.

Alternatively, the data adding unit 28 may display the additional data button 50 at a predetermined position (e.g., an upper right corner) of the designated page Pr since at least association between the designated page Pr and the additional data can be understood as long as the additional data button 50 is displayed within the designated page Pr.

The data adding unit 28 may directly paste (embed) the additional data within the designated page Pr (especially at a part close to the designated part) instead of displaying the additional data button 50.

Since the target data 20 is being executed by the displaying application 22 (being displayed on the touch panel 14), the data adding unit 28 cannot directly edit the target data 20. Therefore, the data adding unit 28 copies the target data 20 to create edit data and adds the additional data to the edit data. When the processing for adding the additional data to the edit data is finished, displayed contents of the displaying application 22 are updated so that the edit data that has been edited is displayed as the target data 20.

It is desirable that the data adding unit 28 switches the operation mode of the displaying application 22 from the edit mode back to the view mode promptly after the processing for adding the additional data to the target data 20 is finished. This prevents the user from performing an unintended action on the target data 20 on the displaying application 22 after addition of the additional data.

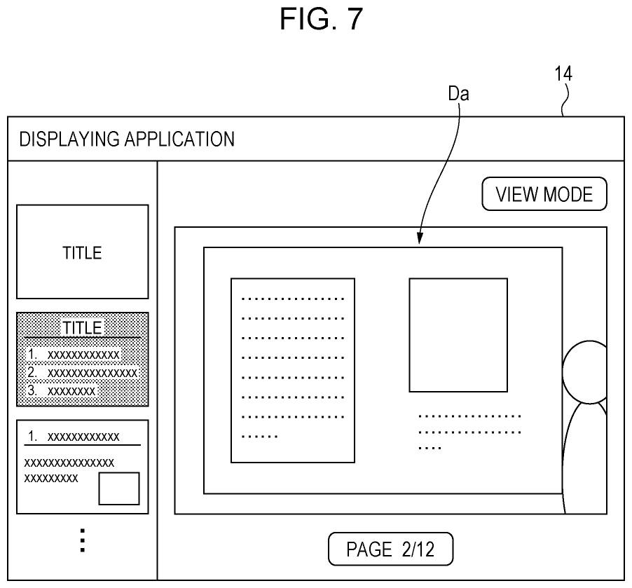

When the additional data button 50 is operated by the user after the additional data is added to the target data 20, additional data Da is displayed on the displaying application 22 as illustrated in FIG. 7.

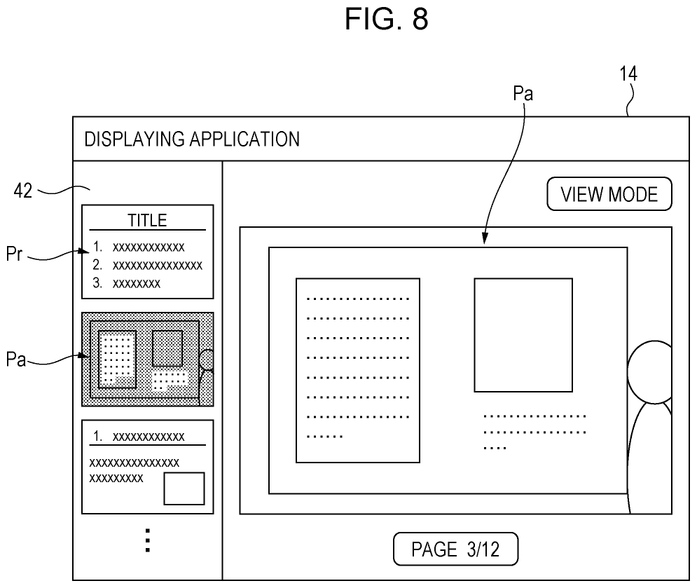

Although the additional data Da is added within the designated page Pr including the designated part in association with the designated part in the above example, the additional data Da may be added as a new page close to the designated page Pr, in other words, as a page preceding or succeeding the designated page Pr in association with the designated part. The additional data Da added as a new page is referred to as an additional data page Pa. The thumbnail display region 42 of FIG. 8 shows that the additional data page Pa has been added as a page next to the designated page Pr including the designated part.

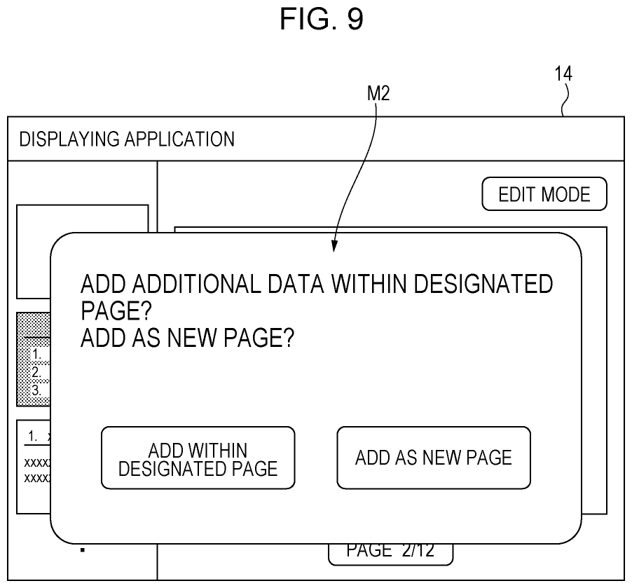

The data adding unit 28 may inquire of the user whether to add the additional data Da within the designated page Pr including the designated part or add the additional data Da as a new page close to the designated page Pr (i.e., add the additional data page Pa) when the designated part and the additional data Da are designated by the user. For example, the data adding unit 28 causes an inquiring message M2 (see FIG. 9)) to be displayed on the touch panel 14. The data adding unit 28 adds the additional data Da to the target data 20 in accordance with an instruction from the user. For example, in a case where the user selects an “ADD WITHIN DESIGNATED PAGE” button on the inquiring message M2 of FIG. 9, the data adding unit 28 adds the additional data Da within the designated page Pr, whereas in a case where the user selects an “ADD AS NEW PAGE” button on the inquiring message M2 of FIG. 9, the data adding unit 28 adds the additional data page Pa close to the designated page Pr.

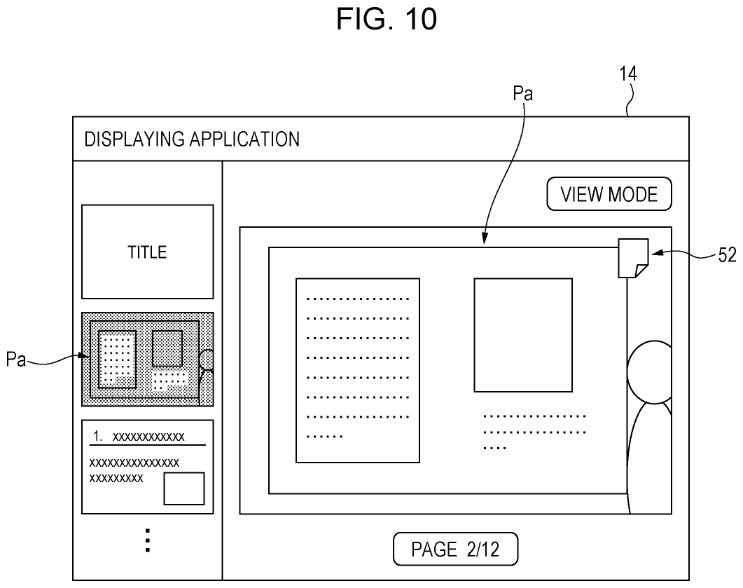

The data adding unit 28 may add the additional data page Pa to the target data 20 as a replacement for the designated page Pr including the designated part. In other words, the data adding unit 28 may replace the designated page Pr with the additional data page Pa. FIG. 10 illustrates a state where the additional data page Pa has been added as a replacement for the designated page Pr. Since the designated page Pr is page 2 as illustrated in FIG. 3 before the additional data page Pa is added, the data adding unit 28 puts the additional data page Pa at page 2 of the target data 20 as a replacement for the designated page Pr. In this case, it is desirable that the data adding unit 28 add a designated page button 52 to the additional data page Pa. When the designated page button 52 is operated by the user, the designated page Pr is displayed on the displaying application 22. Alternatively, in a case where the additional data page Pa is added as a replacement for the designated page Pr, the designated page Pr may be moved to a predetermined page of the target data 20. For example, the designated page Pr may be moved to the last page.

Whether to add the additional data page Pa to the target data 20 as a replacement for the designated page Pr or add the additional data page Pa to the target data 20 while leaving the designated page Pr may be determined by the data adding unit 28 in accordance with an instruction from the user.

### First Modification

In the basic exemplary embodiment, the adding action for adding the additional data to the target data 20 is an action for designating a part of the target data 20 and then acquiring image data by using the camera 16 or an action for designating a part of the target data 20 and then selecting additional data. The first modification is different from the basic exemplary embodiment in the adding action.

For example, there are cases where the user who is listening to a presenter's presentation while viewing the target data 20 on the displaying application 22 does a search about the presentation by operating another application. In this case, the user may want to add image data obtained on the other application (i.e., during the search) to the target data 20.

In the first modification, in a case where a user who is viewing the target data 20 on the displaying application 22 that is in the view mode selects another application and then selects the displaying application 22 again, one or more pieces of image data acquired while the other application is being selected are added as additional data. That is, the adding action according to the first modification is an action for selecting another application and acquiring image data while the other application is being selected.

The other application is, for example, the web browser 24. Image data downloaded on the web browser 24 or image data obtained by capturing a display screen of the web browser 24 can be additional data. Note that the other application is not limited to the web browser 24. For example, the other application may be a camera application for photographing using the camera 16 or may be an image displaying application for displaying image data stored in the memory 18.

Note that the settings may be adjusted so that a screen is automatically captured intermittently while the other application is being selected. In particular, the settings may be adjusted so that a screen is automatically captured on a specific application but a screen is not automatically captured on other applications. For example, the settings may be adjusted so that a screen is not automatically captured on the camera application but a screen is automatically captured on the web browser 24 and the image displaying application.

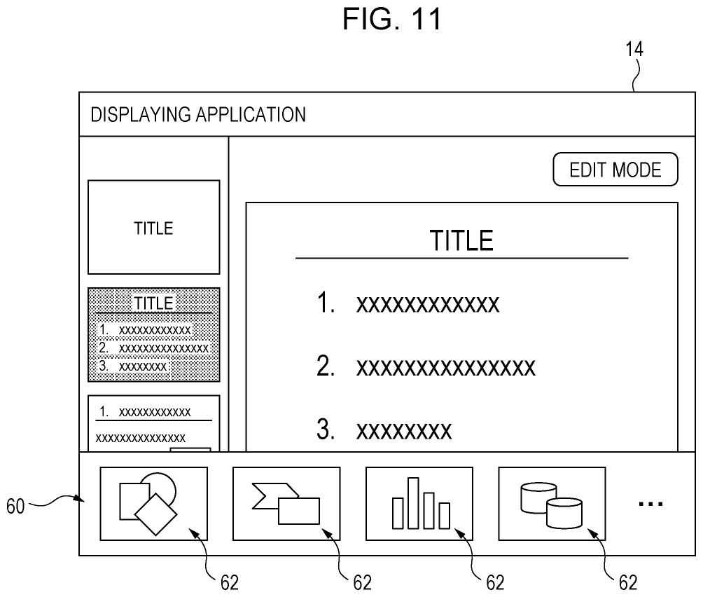

In a case where the user who is viewing the target data 20 on the displaying application 22 that is in the view mode selects another application and then selects the displaying application 22 again, the data adding unit 28 causes one or more pieces of image data acquired while the other application is being selected to be displayed as candidates of additional data on the touch panel 14. For example, as illustrated in FIG. 11, the data adding unit 28 causes a candidate data display region 60 to be displayed and causes candidate data 62, which is the one or more pieces of image data acquired while the other application is being selected, to be displayed in the candidate data display region 60.

One or some of the pieces of image data acquired while the other application is being selected may be excluded from the candidate data 62. For example, in a case where the other application is a camera application, images such as a blurred image and an image of inappropriate luminance may be excluded from the candidate data 62. Specifically, the data adding unit 28 may perform image analysis on the pieces of image data acquired while the other application is being selected and exclude, from the candidate data 62 displayed in the candidate data display region 60, images such as an image (i.e., an image on which an edge is not sharp) having no pixel whose difference in pixel value from an adjacent pixel is equal to or larger than a threshold value, an image (i.e., an image that is white on the whole) whose average luminance is equal to or larger than a first luminance threshold value, and an image (i.e., an image that is black on the whole) whose average luminance is equal to or less than a second luminance threshold value.

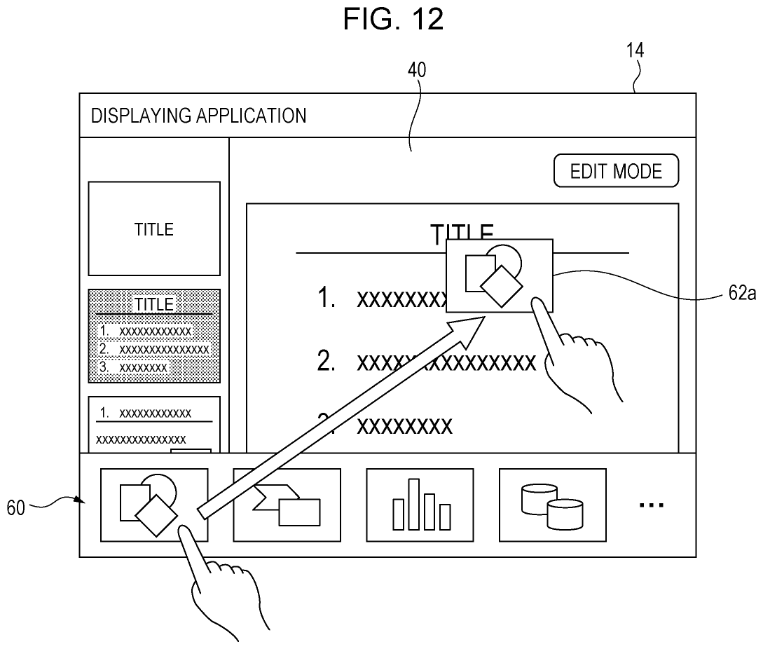

The user can select additional data to be added to the target data 20 from among the displayed pieces of candidate data 62. The user may designate a part of the target data 20 together with the additional data. For example, by dragging one of the pieces of candidate data 62 displayed in the candidate data display region 60 to a part of a page displayed in the first display region 40 and then dropping this candidate data 62 at this part as illustrated in FIG. 12, the user can not only select additional data, but also designate a part of the target data 20. In the example of FIG. 12, candidate data 62a is designated as additional data, and Point 1 of the page displayed in the first display region 40 is designated as a designated part. In this case, the candidate data 62a is added as additional data in association with the designated part. How the additional data is added may be similar to that in the basic exemplary embodiment.

### Second Modification

In the second modification, in a case where a user who is viewing the target data 20 on the displaying application 22 that is in the view mode opens a web page on the web browser 24 and then selects the displaying application 22 again, a URL of the web page viewed on the web browser is added as additional data. That is, an adding action in the second modification is an action for opening a web page on a web browser.

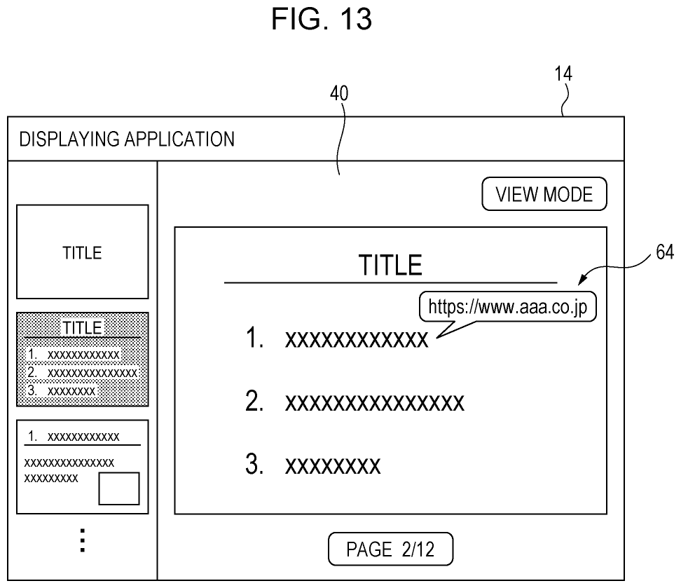

In a case where a user who is viewing the target data 20 on the displaying application 22 that is in the view mode selects the web browser 24, the data adding unit 28 acquires a URL of a web page viewed on the web browser 24. Then, when the user selects the displaying application 22 again, the data adding unit 28 adds the URL to the target data 20 as additional data. The data adding unit 28 may add the URL as additional data in association with a page that was displayed in the first display region 40 when the web browser 24 was selected. When the user selects the displaying application 22 again, the user may designate a part of the target data 20 and add the URL in association with the designated part. An URL(s) of one or more webpages viewed on the web browser 24 may be displayed as candidates of additional data on the touch panel 14, and the user may select an URL to be added as additional data from among these candidates, as in the first modification. FIG. 13 illustrates a state where Point 1 of a page displayed on the first display region 40 has been designated, and a URL 64 has been added in association with the designated part.

### Third Modification

An adding action in the third modification is an action for selecting additional data, for example, from a menu while the target data 20 is being displayed on the displaying application 22 that is in the view mode without designating a part of the target data 20. In this case, the additional data may be added in association with a page displayed in the first display region 40 when the action for selecting the additional data is performed since no part is designated.

In a case where the target data 20 is electronic document data, a position where additional data is to be added may be determined depending on the kind of electronic document data. In particular, a position (page) where additional data page Pa is to be added may be determined depending on the kind of electronic document data. For example, in a case where the target data 20 is a conference material related to contents of a conference, the additional data page Pa is added to a page next to a page displayed in the first display region 40 when the action for selecting the additional data is performed, whereas in a case where the target data 20 is not related to contents of the conference (e.g., in a case where the target data 20 is a conference guide that gives information on a place where the conference is held and a time window during which the conference is held), the additional data page Pa may be added to a predetermined position (e.g., the last page).

### Flow of Processing of Basic Exemplary Embodiment

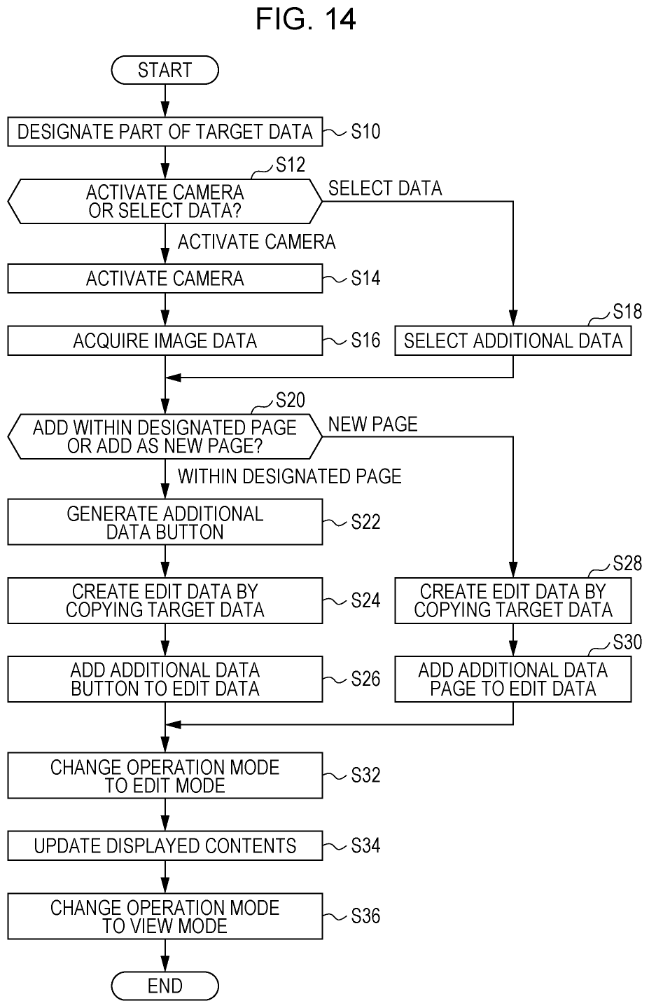

Flow of processing of the information processing apparatus 10 according to the basic exemplary embodiment is described below with reference to the flowchart of FIG. 14. In the following description, it is assumed that a user is viewing the target data 20 on the displaying application 22 that is in the view mode at the time of start of the flowchart of FIG. 14.

In step S10, the user designates a part of the target data 20. For example, as illustrated in FIG. 3, the user designates a part of a page displayed in the first display region 40 on the displaying application 22 by long-pressing this part with a finger.

In step S12, the data adding unit 28 causes an inquiring message M1 (see FIG. 4) inquiring of the user whether to activate the camera 16 or select prepared data to be displayed on the touch panel 14. In a case where the user chooses to activate the camera 16 on the inquiring message M1, step S14 is performed.

In step S14, the data adding unit 28 activates the camera 16 and causes a photographing screen (FIG. 5) to be displayed on the touch panel 14.

In step S16, the user takes an image by using the camera 16 and acquires image data as additional data Da.

Meanwhile, in a case where the user chooses to select data on the inquiring message M1 in step S12, step S18 is performed.

In step S18, the user selects data stored in the memory 18 or another apparatus as additional data Da.

In step S20, the data adding unit 28 causes an inquiring message M2 (see FIG. 9) inquiring of the user whether to add the additional data Da within a designated page Pr including the designated part or add the additional data Da as a new page close to the designated page Pr (i.e., add additional data page Pa) to be displayed on the touch panel 14. In a case where the user chooses to add the additional data Da within the designated page Pr on the inquiring message M2, step S22 is performed.

In step S22, the data adding unit 28 generates an additional data button 50 on the basis of the additional data Da.

In step S24, the data adding unit 28 creates edit data by copying the target data 20 displayed on the displaying application 22.

In step S26, the data adding unit 28 adds the additional data button 50 generated in step S22 to the edit data created in step S24 in association with the part designated by the user in step S10.

Meanwhile, in a case where the user chooses to add the additional data Da as a new page close to the designated page Pr on the inquiring message M2 in step S20, step S28 is performed.

In step S28, the data adding unit 28 creates edit data by copying the target data 20 displayed on the displaying application 22 as in step S24.

In step S30, the data adding unit 28 adds the additional data page Pa to the edit data created in step S28 as a page close to the designated page Pr.

In step S32, the data adding unit 28 changes the operation mode of the displaying application 22 to the edit mode.

In step S34, the data adding unit 28 updates displayed contents of the displaying application 22 so that the target data 20 to which the additional data Da has been added in step S26 or the additional data page Pa has been added in step S30 is displayed on the displaying application 22.

In step S36, the data adding unit 28 changes the operation mode of the displaying application 22 to the view mode.

Although the exemplary embodiment of the present disclosure has been described above, the present disclosure is not limited to the above exemplary embodiment and can be modified in various ways without departing from the spirit of the present disclosure.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor; and
a touch panel on which target data is displayed,
wherein the processor is configured to add additional data to the target data after switching an operation mode from a view mode, in which the target data is uneditable, to an edit mode, in which the target data is editable, in response to an operator's action for adding the additional data to the target data in the view mode.

2. The information processing apparatus according to claim 1, wherein
in a case where the adding action includes designating a part of the target data, the processor adds the additional data in association with the designated part.

3. The information processing apparatus according to claim 2, wherein
the target data is an electronic document having one or more pages;
the designated part is a part within a page of the electronic document;
the processor adds an additional data button in association with the part within the page of the electronic document; and
the additional data is displayed when the additional data button is operated.

4. The information processing apparatus according to claim 2, wherein
the target data is an electronic document having one or more pages; and
the processor decides whether to add the additional data within a designated page including the designated part or add the additional data as a new page close to the designated page in accordance with an instruction from the operator.

5. The information processing apparatus according to claim 2, wherein
the target data is an electronic document having one or more pages;
the processor adds the additional data as a new page as a replacement for a designated page including the designated part and adds a designated page button to the new page; and
the designated page is displayed when the designated page button is operated.

6. The information processing apparatus according to claim 1, wherein
the adding action is an action for designating image data; and
the processor adds the image data to the target data.

7. The information processing apparatus according to claim 2, wherein
the adding action is an action for designating image data; and
the processor adds the image data to the target data.

8. The information processing apparatus according to claim 3, wherein
the adding action is an action for designating image data; and
the processor adds the image data to the target data.

9. The information processing apparatus according to claim 4, wherein
the adding action is an action for designating image data; and
the processor adds the image data to the target data.

10. The information processing apparatus according to claim 5, wherein
the adding action is an action for designating image data; and
the processor adds the image data to the target data.

11. The information processing apparatus according to claim 6, further comprising a camera,
wherein the adding action is an action for acquiring the image data by using the camera.

12. The information processing apparatus according to claim 7, further comprising a camera,
wherein the adding action is an action for acquiring the image data by using the camera.

13. The information processing apparatus according to claim 8, further comprising a camera,
wherein the adding action is an action for acquiring the image data by using the camera.

14. The information processing apparatus according to claim 9, further comprising a camera,
wherein the adding action is an action for acquiring the image data by using the camera.

15. The information processing apparatus according to claim 10, further comprising a camera,
wherein the adding action is an action for acquiring the image data by using the camera.

16. The information processing apparatus according to claim 6, wherein
in a case where the operator, who is viewing the target data on a displaying application operating on the information processing apparatus, selects another application and then selects the displaying application again, the processor causes one or more pieces of image data acquired while the other application is being selected to be displayed as candidates of the additional data on the touch panel.

17. The information processing apparatus according to claim 7, wherein
in a case where the operator, who is viewing the target data on a displaying application operating on the information processing apparatus, selects another application and then selects the displaying application again, the processor causes one or more pieces of image data acquired while the other application is being selected to be displayed as candidates of the additional data on the touch panel.

18. The information processing apparatus according to claim 1, wherein
in a case where the operator, who is viewing the target data on a displaying application operating on the information processing apparatus, opens a web page on a web browser and then selects the displaying application again, the processor adds an URL of the web page to the target data as the additional data.

19. The information processing apparatus according to claim 1, wherein
the target data is an electronic document having one or more pages; and
the processor adds the additional data as a new page at a position corresponding to a kind of the target data.

20. A non-transitory computer readable medium storing a program causing a computer having a touch panel to execute a process for information processing, the process comprising:
adding additional data to target data displayed on the touch panel after switching an operation mode from a view mode, in which the target data is uneditable, to an edit mode, in which the target data is editable, in response to an operator's action for adding the additional data to the target data in the view mode.
